(19) United States
(12) Patent Application Publication
(10) Pub. No.: US 2006/0066557 A1
(43) Pub. Date: Mar. 30, 2006

(54) Method and device for reflective display with time sequential color illumination

(76) Inventor: Philip D. Floyd, Redwood City, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/083,841

(22) Filed: Mar. 18, 2005

Related U.S. Application Data
(60) Provisional application No. 60/613,375, filed on Sep. 27, 2004.

(51) Int. Cl. G09G 3/36

(52) U.S. Cl. 345/102

(57) ABSTRACT

In various embodiments of the invention, a display device comprises an illumination apparatus configured to emit light of a different color at different times and at least one interferometric light modulating device illuminated by the illumination apparatus. In certain preferred embodiments, interferometric light modulating devices are illuminated for short durations with different color light, the durations of the time being sufficiently short to produce color fusion or blending of colors as perceived by the human eye. The interferometric light modulating device may comprise a white interferometric light modulating device that reflects white light in one state. The interferometric light modulating device may also have a reflectivity spectrum that includes a least two color peaks.

### CROSS-REFERENCE TO RELATED APPLICATIONS

This application claims priority under 35 U.S.C. § 119(e) to U.S. Provisional Application No. 60/613,375, filed on Sep. 27, 2004, which is hereby incorporated by reference in its entirety.

### BACKGROUND

The field of the invention relates to micro-electro-mechanical (MEMS) systems. More specifically, the invention relates to light modulation, including interferometric light modulation.

MEMS include micro mechanical elements, actuators, and electronics. Micromechanical elements may be created using deposition, etching, and or other micromachining processes that etch away parts of substrates and/or deposited material layers or that add layers to form electrical and electromechanical devices.

Spatial light modulators are an example of MEMS systems. Spatial light modulators used for imaging applications come in many different forms. Transmissive liquid crystal device (LCD) modulators modulate light by controlling the twist and/or alignment of crystalline materials to block or pass light. Reflective spatial light modulators exploit various physical effects to control the amount of light reflected to the imaging surface. Examples of such reflective modulators include reflective LCDs, and digital micromirror devices (DMD™).

Another example of a spatial light modulator is an interferometric modulator that modulates light by interference. An interferometric modulator may comprise a pair of conductive plates, one or both of which may be transparent and/or reflective in whole or part and capable of relative motion upon application of an appropriate electrical signal. One plate may comprise a stationary layer deposited on a substrate, the other plate may comprise a metallic membrane separated from the stationary layer by an air gap. Such devices have a wide range of applications, and it would be beneficial in the art to utilize and/or modify the characteristics of these types of devices so that their features can be exploited in improving existing products and creating new products that have not yet been developed. An iMoD™ is one example of an interferometric light modulator. The iMoD employs a cavity having at least one movable or deflectable wall. As the wall, typically comprised at least partly of metal, moves towards a front surface of the cavity, interference occurs that affects the color of light viewed at the front surface. The front surface is typically the surface where the image seen by the viewer appears, as the iMoD is a direct-view device.

### SUMMARY

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments” one will understand how the features of this invention provide advantages over other display devices.

In various embodiments of the invention, a display device comprises an illumination apparatus configured to emit light of different color at different times and at least one interferometric light modulating device illuminated by the illumination apparatus. In certain preferred embodiments, interferometric light modulating devices are illuminated for short durations with different color light, the durations of the time being sufficiently short to produce color fusion or blending of colors as perceived by the human eye. The interferometric light modulating device may comprise a white interferometric light modulating device that reflects white light in one state. The interferometric light modulating device may also have a reflectivity spectrum that includes a least two color peaks.

In another embodiment, a display device is provided, comprising: at least one interferometric light modulator configured to reflect light, said at least one interferometric light modulator configured to reflect light comprising a spectral response including two or more reflectance peaks in the visible spectrum; and a light source having an emission spectra that includes at least one emission peak at least partially overlapping one of said two or more reflectance peaks.

In another embodiment, a display device is provided, comprising: means for modulating light, wherein the means for modulating light is capable of reflecting light having a plurality of intensity peaks in the visible spectrum; and means for selectively illuminating said means for modulating light with light including at least said plurality of intensity peaks in the visible spectrum.

In another embodiment, a method of manufacturing an interferometric light modulating device is provided, comprising: providing a plurality of pixel elements, each pixel element comprising at least one interferometric light modulator configured to reflect light comprising a spectral response that includes two or more reflectance peaks in the visible spectrum; and providing a light source configured to selectively illuminate said plurality of pixel elements with light having one or more spectral peaks substantially overlapping said two or more reflectance peaks.

In another embodiment, an interferometric light modulating device, comprising: a plurality of pixel elements, each pixel element comprising a plurality of interferometric light modulators switchable between different reflective states; an illumination apparatus configured to selectively illuminate the plurality of pixel elements with light of different color at different times; and a control system configured to control the color of said light with which said pixel elements are illuminated.

In another embodiment, a display device is provided, comprising: an illumination apparatus configured to emit light comprising an emission spectra having a variable spectral output; at least one light modulating device configured to reflect light from said illumination apparatus, said at least one light modulating device comprising an optical cavity formed by a pair of reflective plates; and a control system configured to control the spectral output of the illumination apparatus.

In another embodiment, an interferometric light modulating device is provided, comprising: means for interferometrically modulating light switchable between different reflective states; and means for selectively illuminating said means for interferometrically modulating light with light of different color at different times.

### BRIEF DESCRIPTION OF THE DRAWINGS

FIG. 1 is an isometric view depicting a portion of one embodiment of an interferometric modulator display in which a movable reflective layer of a first interferometric modulator is in a released position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIG. 6A is a cross section of the device of FIG. 1.

FIG. 6B is a cross section of an alternative embodiment of an interferometric modulator.

FIG. 6C is a cross section of another alternative embodiment of an interferometric modulator.

FIG. 7A illustrates an interferometric modulator array of substantially identical modulators.

FIG. 7B illustrates the integration of the modulator array illustrated in FIG. 7A with a waveguide and multi-colored light source.

FIG. 8 is a plot on axis of reflectivity versus wavelength of a reflective response an exemplary interferometric modulator.

FIG. 9 provides a block diagram illustrating the spatial and temporal mixing that occurs in a system.

FIG. 10 provides a flowchart that illustrates the control of an interferometric modulator array in conjunction with a multicolored light source.

FIG. 11 is an exemplary interferometric light modulator.

### DETAILED DESCRIPTION OF THE PREFERRED EMBODIMENTS

In various embodiments of the invention, a plurality of interferometric modulators are illuminated with an illumination apparatus that emits different color light at different times. This illumination apparatus may emit different colors (e.g., red, green, and blue) in a sequence that is repeated. This illumination apparatus may comprise, for example, a red, a green, and a blue light emitting diode. The interferometric modulators may, in such a case, be illuminated with red light over a first time period, with green light over a second time period, and with blue light over a third period. This colored light is reflected from the interferometric modulators to a viewer. In certain preferred embodiments, the durations of the time periods are sufficiently short to produce color fusion or blending of colors as perceived by the eye of the viewer. The interferometric light modulators may switch faster than the time period. The interferometric light modulating device may comprise a white interferometric light modulating device that reflects white light in one state. This white light interferometric modulator will also reflect the color light from the illumination apparatus. The interferometric light modulating device may also have a reflectivity spectrum that includes at least two color peaks. These two color peaks may overlap with colors emitted by the illumination apparatus.

Advantageously, various exemplary embodiments may comprise a plurality of interferometric light modulators wherein each of the light modulating elements includes an optical cavity that is designed to provide essentially the same optical response. In certain embodiments, for example, when an optical cavity is closed on one of the interferometric light modulators, the color black will be the spectral response. Conversely, when the optical cavity is open, light is reflected having a predetermined spectral response. This predetermined optical response may be broadband white, such that a wide range of colors incident on the mirror will be reflected with approximately equal intensity. Alternatively, this optical response may include a plurality of separate colors peaks, such as red, blue and green color peaks, similar to the colors produced by the illumination apparatus.

As described above, the illumination apparatus may comprise a multi-colored light source. The color(s) reflected by the interferometric light modulators may be controlled by the spectrum of light emitted by the multi-colored light source and directed towards the light modulators. A control system may be provided that controls the interferometric modulators so as to create images having the desired colors. In some embodiments, the control system may also control the output of the light source and thus the illumination of the interferometric modulators. The control system may be referred to herein as a control processor and may comprise one or more electronics devices or other control or computational devices. The control system may comprise, for example, a processor and an array controller. The control system may comprise a microprocessor in some embodiments.

The following detailed description is directed to certain specific embodiments of the invention. However, the invention can be embodied in a multitude of different ways. In this description, reference is made to the drawings wherein like parts are designated with like numerals throughout. As will be apparent from the following description, the invention may be implemented in any device that is configured to display an image, whether in motion (e.g., video) or stationary (e.g., still image), and whether textual or pictorial. More particularly, it is contemplated that the invention may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

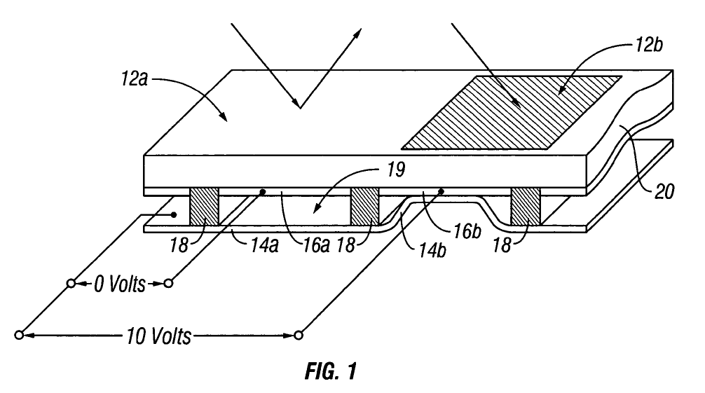

One interferometric modulator display embodiment comprising an interferometric MEMS display element is illustrated in FIG. 1. In these devices, the pixels are in either a bright or dark state. In the bright (“on” or “open”) state, the display element reflects a large portion of incident visible light to a user. When in the dark (“off” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical cavity with at least one variable dimension. In one embodiment, one of the reflective layers may be moved between two positions. In the first position, referred to herein as the released state, the movable layer is positioned at a relatively large distance from a fixed partially reflective layer. In the second position, the movable layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable and highly reflective layer 14a is illustrated in a released position at a predetermined distance from a fixed partially reflective layer 16a. In the interferometric modulator 12b on the right, the movable highly reflective layer 14b is illustrated in an actuated position adjacent to the fixed partially reflective layer 16b.

The fixed layers 16a, 16b are electrically conductive, partially transparent and partially reflective, and may be fabricated, for example, by depositing one or more layers each of chromium and indium-tin-oxide onto a transparent substrate 20. The layers are patterned into parallel strips, and may form row electrodes in a display device as described further below. The movable layers 14a, 14b may be formed as a series of parallel strips of a deposited metal layer or layers (orthogonal to the row electrodes 16a, 16b) deposited on top of posts 18 and an intervening sacrificial material deposited between the posts 18. When the sacrificial material is etched away, the deformable metal layers are separated from the fixed metal layers by a defined air gap 19. A highly conductive and reflective material such as aluminum may be used for the deformable layers, and these strips may form column electrodes in a display device.

With no applied voltage, the cavity 19 remains between the layers 14a, 16a and the deformable layer is in a mechanically relaxed state as illustrated by the pixel 12a in FIG. 1. However, when a potential difference is applied to a selected row and column, the capacitor formed at the intersection of the row and column electrodes at the corresponding pixel becomes charged, and electrostatic forces pull the electrodes together. If the voltage is high enough, the movable layer is deformed and is forced against the fixed layer (a dielectric material which is not illustrated in this Figure may be deposited on the fixed layer to prevent shorting and control the separation distance) as illustrated by the pixel 12b on the right in FIG. 1. The behavior is the same regardless of the polarity of the applied potential difference. In this way, row/column actuation that can control the reflective vs. non-reflective pixel states is analogous in many ways to that used in conventional LCD and other display technologies.

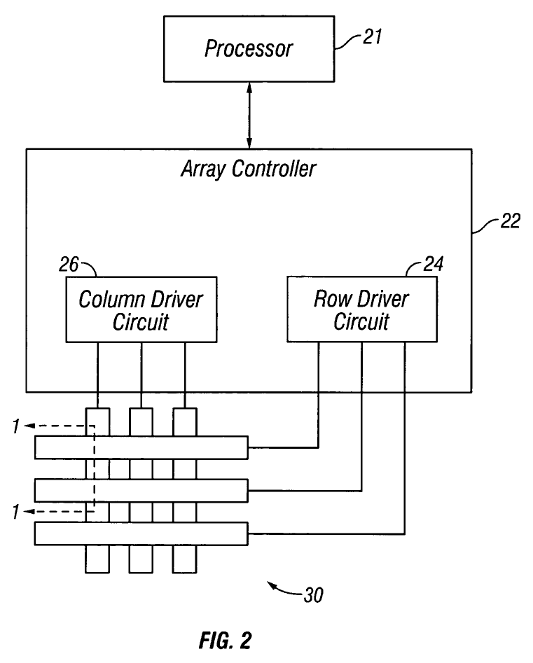

FIGS. 2 through 5 illustrate one exemplary process and system for using an array of interferometric modulators in a display application. FIG. 2 is a system block diagram illustrating one embodiment of an electronic device that may incorporate aspects of the invention. In the exemplary embodiment, the electronic device includes a processor 21 which may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

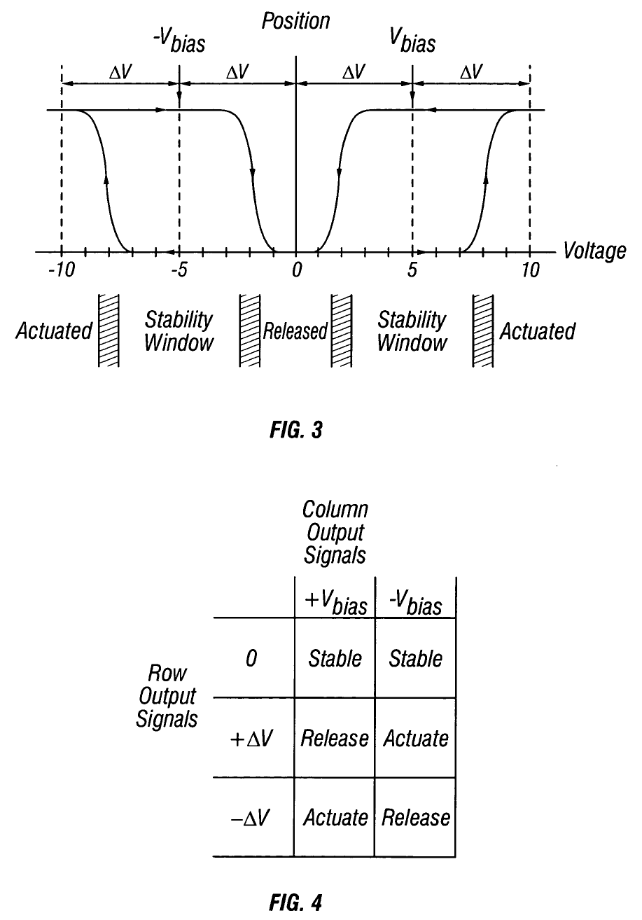

In one embodiment, the processor 21 is also configured to communicate with an array controller 22. In one embodiment, the array controller 22 includes a row driver circuit 24 and a column driver circuit 26 that provide signals to a pixel array 30. The cross section of the array illustrated in FIG. 1 is shown by the lines 1-1 in FIG. 2. For MEMS interferometric modulators, the row/column actuation protocol may take advantage of a hysteresis property of these devices illustrated in FIG. 3. It may require, for example, a 10 volt potential difference to cause a movable layer to deform from the released state to the actuated state. However, when the voltage is reduced from that value, the movable layer maintains its state as the voltage drops back below 10 volts. In the exemplary embodiment of FIG. 3, the movable layer does not release completely until the voltage drops below 2 volts. There is thus a range of voltage, about 3 to 7 V in the example illustrated in FIG. 3, where there exists a window of applied voltage within which the device is stable in either the released or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be released are exposed to a voltage difference of close to zero volts. After the strobe, the pixels are exposed to a steady state voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or released pre-existing state. Since each pixel of the interferometric modulator, whether in the actuated or released state, is essentially a capacitor formed by the fixed and moving reflective layers, this stable state can be held at a voltage within the hysteresis window with almost no power dissipation. Essentially no current flows into the pixel if the applied potential is fixed.

In typical applications, a display frame may be created by asserting the set of column electrodes in accordance with the desired set of actuated pixels in the first row. A row pulse is then applied to the row 1 electrode, actuating the pixels corresponding to the asserted column lines. The asserted set of column electrodes is then changed to correspond to the desired set of actuated pixels in the second row. A pulse is then applied to the row 2 electrode, actuating the appropriate pixels in row 2 in accordance with the asserted column electrodes. The row 1 pixels are unaffected by the row 2 pulse, and remain in the state they were set to during the row 1 pulse. This may be repeated for the entire series of rows in a sequential fashion to produce the frame. Generally, the frames are refreshed and/or updated with new display data by continually repeating this process at some desired number of frames per second. A wide variety of protocols for driving row and column electrodes of pixel arrays to produce display frames are also well known and may be used in conjunction with the present invention.

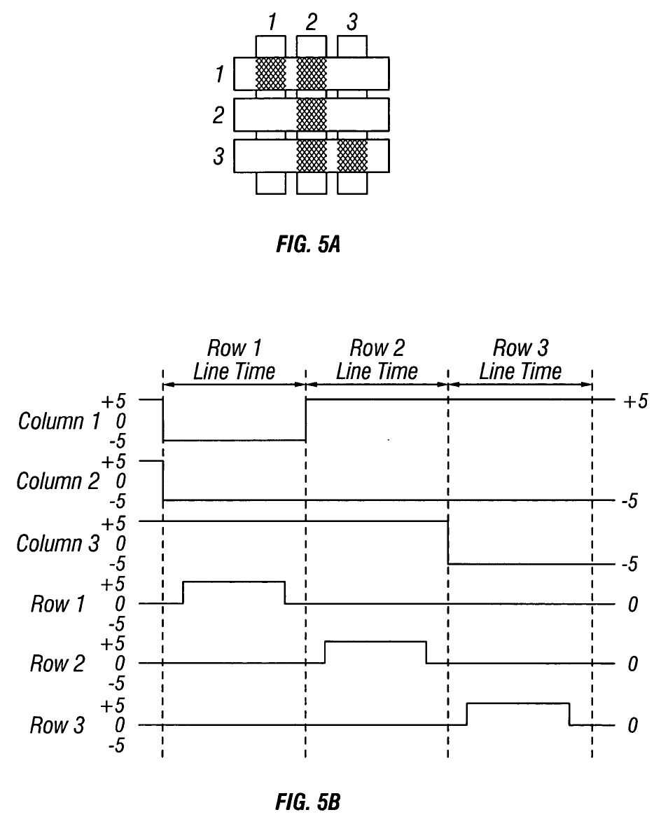

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −Vbias, and the appropriate row to +ΔV, which may correspond to −5 volts and +5 volts respectively Releasing the pixel is accomplished by setting the appropriate column to +Vbias, and the appropriate row to the same +ΔV, producing a zero volt potential difference across the pixel. In those rows where the row voltage is held at zero volts, the pixels are stable in whatever state they were originally in, regardless of whether the column is at +Vbias, or −Vbias. As is also illustrated in FIG. 4, it will be appreciated that voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are at 0 volts, and all the columns are at +5 volts. With these applied voltages, all pixels are stable in their existing actuated or released states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and releases the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and release pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any actuation voltage method can be used with the present invention.

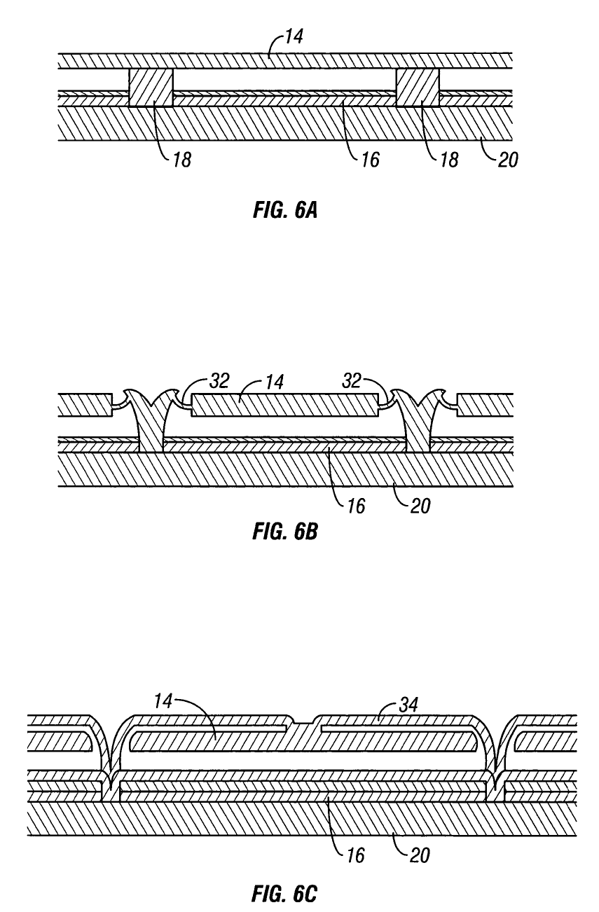

The details of the structure of interferometric modulators that operate in accordance with the principles set forth above may vary widely. For example, FIGS. 6A-6C illustrate three different embodiments of the moving mirror structure. FIG. 6A is a cross section of the embodiment of FIG. 1, where a strip of metal material 14 is deposited on orthogonally extending supports 18. In FIG. 6B, the moveable reflective material 14 is attached to supports at the corners only, on tethers 32. In FIG. 6C, the moveable reflective material 14 is suspended from a deformable layer 34. This embodiment has benefits because the structural design and materials used for the reflective material 14 can be optimized with respect to the optical properties, and the structural design and materials used for the deformable layer 34 can be optimized with respect to desired mechanical properties. The production of various types of interferometric devices is described in a variety of published documents, including, for example, U.S. published Application 2004/0051929. A wide variety of well known techniques may be used to produce the above described structures involving a series of material deposition, patterning, and etching steps.

As described above, in certain embodiments, the interferometric modulators may be illuminated with light from an illumination apparatus that varies the color of illumination provided at different times. A sequence of colors such as for example, red, green, and blue may therefore be used to illuminate the interferometric modulators. The interferometric modulators selectively reflect this light to produce a color image.

As described above, interferometric modulators can be provided in arrays and are addressed to provide the desired display. Addressing directs the selected modulator to provide a predetermined optical response. The elements can be individually addressed or in the preferred embodiment can be addressed by means of strobing one set of electrodes and providing data on the other electrodes. (One preferred method of addressing reduces the number of control signals necessary to drive the display. This is described in detail in U.S. Pat. No. 5,986,796, entitled “Visible Spectrum Modulator Arrays” assigned to the assignee of the present invention.)

Accordingly, various embodiments comprise a display having an array of interferometric modulators, which when combined with an appropriately driven multi-colored light source can be used to produce colored images. Such a display is capable of being used as either a direct view color display or a projection color display. As described above, in certain embodiments a black state is produced when the interferometric modulator is actuated with the optical resonance cavity collapsed. In the released position with the cavity open, the interferometric modulators are designed to provide a predetermined reflection characteristic, which can either be broadband white such that a range of colors incident on the mirror will be reflected with approximately equal intensity or are tuned to have are reflectivity spectrum with a plurality of reflectance peaks overlapping or corresponding to the colors transmitted by the multi-colored light source. When an array of modulators of the type described above is combined with sequential illumination of the array by a set of primary colors such as red, green, and blue light, full color direct-view and projection displays can be realized. Utilizing high-speed light sources, such as LEDs, it is possible to make the color-field time much shorter than the response time of the eye, allowing for color fusion.

By implementing a full color display to be realized using a uniform array of interferometric modulators, the fabrication process of the display array can be simplified because the interferometric modulators have as single air-gap height and uniform mechanical layer design. This, in turn results in inherent voltage matching, such that the optical response to voltages applied to the electrodes will be substantially identical. In addition, there will be a substantially identical fill factor for each color because the total area of the pixel will be used for each color and the bit depth is independent of pixel layout. In one embodiment, a display fabricated provides a wide color gamut by means of proper light source selection, and allows for low power consumption in emissive-like mode in low ambient light level environments.

One exemplary embodiment provides three integrated parts: (1) an interferometric modulator array designed to reflect with three or more reflectance peaks in the visible spectrum; (2) a light source capable of emitting a set of primary colors, such as a light emitting diode or set of diodes capable of emitting a set of red, green and blue light with emission spectra chosen to match the reflectance peaks of the interferometric modulator array; and (3) a light guide designed to illuminate the interferometric modulator array with the light from the multi-colored light source. The interferometric modulator array is sequentially illuminated by red, green, and blue light. The light is guided on the array by one or more light guides. These light guides may have features (reflective or scatter features, etc.) such as corrugations, causing a portion of the light to deflect and illuminate the array at normal incidence. The light is modulated and at least a portion is reflected normally through the light guide to the viewer.

Another embodiment also provides three integrated parts: (1) an interferometric modulator array designed to reflect with three or more reflectance peaks in the visible spectrum; (2) a light source capable of a broadband spectrum of light including at least a partial overlap of emission spectra corresponding to the reflectance peaks of the interferometric modulator array; and (3) a spectral filter designed to illuminate the interferometric modulator array (or portions thereof) with a particular spectrum of light from the broadband light source. This embodiment may also provide a light guide designed to illuminate the interferometric modulator array (or portions thereof) with the light passing through the spectral filter.

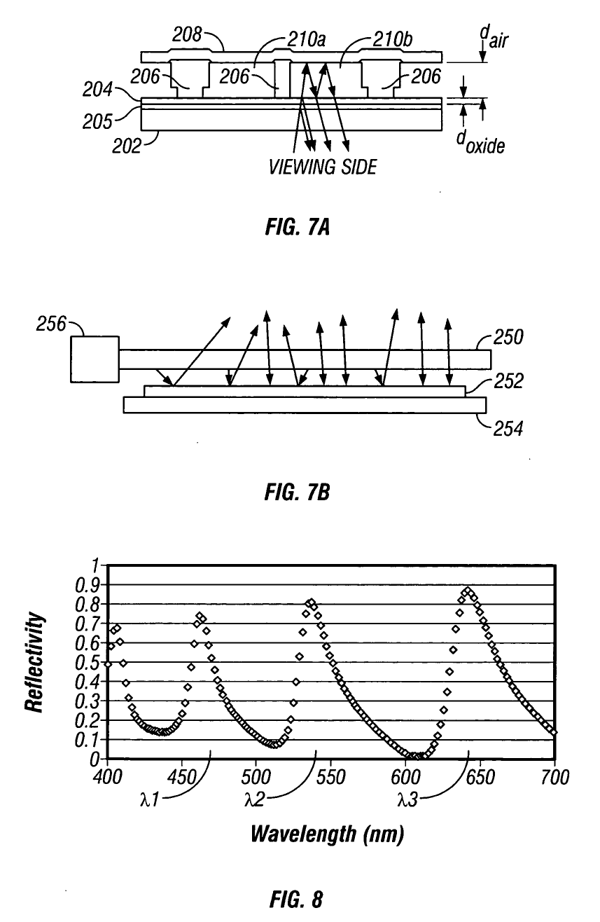

One embodiment of an exemplary array of interferometric modulators is illustrated in FIG. 7A. In particular, FIG. 7A shows two adjacent interferometric modulators structures. Additional details regarding such interferometric modulators are described in above. For the interferometric modulators shown in FIG. 7A, a thin film of absorbing layer 205 is deposited on the substrate 202. In this exemplary embodiment, the conducting/absorbing layer 205 is made from chrome and ITO and substrate 202 may be made of glass. Above conducting/absorbing layer 205, a dielectric layer 204, typically an oxide, is deposited. Support posts 206 are provided to suspend a mechanical/mirror element 208 at a predetermined height above dielectric layer 204 designed to provide an optical response. Additional geometries and materials used in the fabrication of the interferometric modulator structure are discussed in detail in U.S. Pat. No. 5,835,255 and the aforementioned U.S. patent application Ser. No. 09/966,843. As described above, other variations are possible.

In FIG. 7A, the two independent modulators have optical cavities 210a and 210b that determine the optical response of the modulators. These cavities can be actuated or released independently of one another. In one embodiment, the modulators of the display all have essentially the same optical response. However, the color they display will be determined by the color of the illuminating light source and they are designed to reflect multiple wavelengths of light. It will be understood by one skilled in the art that the illustration of only two modulators is for illustrative purposes and that a display will have many more modulators.

In the exemplary embodiment illustrated in FIG. 7A, the interferometric modulators each employ the same air gap distance (dₐᵢᵣ). As the optical response is tuned as a function of the modes of the wavelength of the reflected light, the cavity can be designed to reflect multiple wavelengths. Turning to FIG. 8, the cavity height (dₐᵢᵣ) is selected to be highly reflective in the released state for at least three wavelengths (λ1, λ2 and λ3) represented as peaks in reflectivity. In one embodiment, these peaks correspond to the wavelength of the blue, green and red light emitted by the multi-colored light source. It will be understood by one skilled in the art that the teachings disclosed herein are equally applicable to the case when there are more or less reflective peaks than are illustrated and to the case where the modulator provides a broadband response reflecting peaks across the visible spectrum of light. For example, in one embodiment the cavity height (dₐᵢᵣ) is selected to be highly reflective in the released state for at least two wavelengths, such as cyan and yellow. If peaks in reflectivity are present around wavelengths not corresponding to one of the colors of light transmitted by the light source, those peaks are simply not employed and will not have a pronounced effect on the operation. In another embodiment, the light modulator is a broadband white light modulator providing a broadband response reflecting a wide range of wavelengths across the visible spectrum of light. The light source and/or the spectral filter will control what color is reflected by the light modulator since it will reflect the light spectrum fed to it.

FIG. 7B illustrates an exemplary display configuration. Light source 256 provides different color at different times. In the exemplary embodiment, the light source is a light emitting diode, capable of sequentially emitting primary colors of light. In the exemplary embodiment, light source 256 will emit red light during a first time interval, green light during a second time interval and blue light during a third time interval. It will be understood by one skilled in the art that the any light source capable of sequentially emitting colors such as lamp & color wheels, rotating lamp & filter assemblies, and lamp/filter/rotating prism combinations may be used and need not be limited to the most common set of primary colors red, green and blue.

The light passes through one or more light guides 250. The light is directed through light guide 250 onto interferometric modulator array 252. Interferometric modulator array 252 is provided on substrate 254. Exemplary light guides may have features (reflective features, scatter features, etc.) such as corrugations on the light guide that cause some of the light to deflect and illuminate the array at normal incidence. Although normal deflection of light towards the array 252 is ideal, a normal reflective angle may not be a dominate reflective angle, as illustrated by FIG. 7B. In turn, some of the light is modulated and reflected normally through the light guide to the viewer by interferometric modulator array 252. Again, some of the light reflected by the array 252 may be at a non-normal angle.

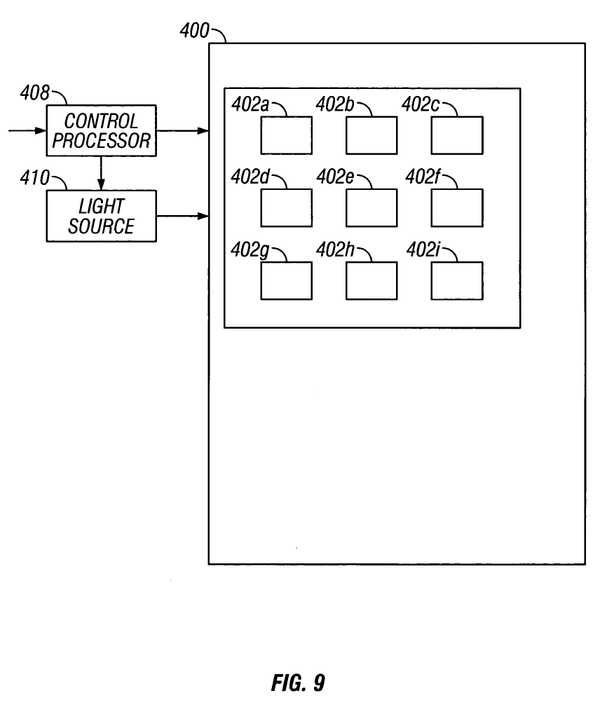

FIG. 9 provides a block diagram of an exemplary display. Control processor 408 provides signals to display 400. Display 400 comprises a large number of pixel elements. Pixel elements 402a-402i are provided for illustrative purposes. Pixel elements 402a-402i are independently addressable. Traditionally, pixel elements 402a-420i would comprise color specific sub pixels that would be responsible for displaying the colors red, blue, or green. However in one embodiment, pixel elements 402a-402i are capable of displaying all three colors and the color displayed is determined by the color of the light emitted by light source 410. In this particular embodiment, the pixel elements 402a-402i are implemented using interferometric modulators.

The human eye in combination with the human brain integrates images which are altered faster than the capacity to be viewed individually. It is this integration that allows a sequence of images flashed at a rapid rate to appear to the viewer as continuous motion video. This integrating aspect of human sight is exploited as described herein in a different manner. If the color red and the color blue are alternately flashed at a viewer at a rapid enough rate, the viewer will see the color purple because the brain will in essence integrate or low pass filter the rapidly changing images.

Accordingly, control processor 408 receives an indication of the desired color to be displayed by each of the pixel elements 402a-i. Control processor 408 determines the ratio of red green and blue needed to produce this color. Based on this ratio a first number of interferometric modulators 402a-i will be selected to be in the released position (the cavity will be open) while light source 410 is emitting red light, a second number of interferometric modulators 402a-i will be selected to be in the released position (the cavity will be open) while light source 410 is emitting green light, and a third number of interferometric modulators 402a-i will be selected to be in the released position (the cavity will be open) while light source 410 is emitting blue light. By strobing sequentially through the red, green and blue colors fast enough an arbitrarily large color gamut can be realized.

In order to adjust the intensity of the displayed color, control processor 408 uses temporal dithering whereby the displayed color is flashed at a select number of the pixel elements 402a-i at predetermined intervals while the modulators of the select pixel elements 402a-i are actuated. When a modulator of a pixel element 402a-i is actuated, the pixel element displays black. By integrating this black state into the flashed sequence, the intensity of the color produced as described above can be reduced. In the preferred embodiment, the two methods described above can be used in conjunction with one another to provide the optimal pixel pattern displaying both the correct intensity and color. That is to say, the frames actively displaying color can be combined with the frames displaying black to adjust the intensity.

In addition, various embodiments provide display flexibility by permitting control processor 408 to control the color sequence, duty cycle and/or intensity of the light source 410. The output of the light source may be varied depending on the content of the images or other conditions. For example, under conditions requiring fewer colors (small color gamut), one or more light sources could be disabled. This has the advantage of reducing power consumption of the display.

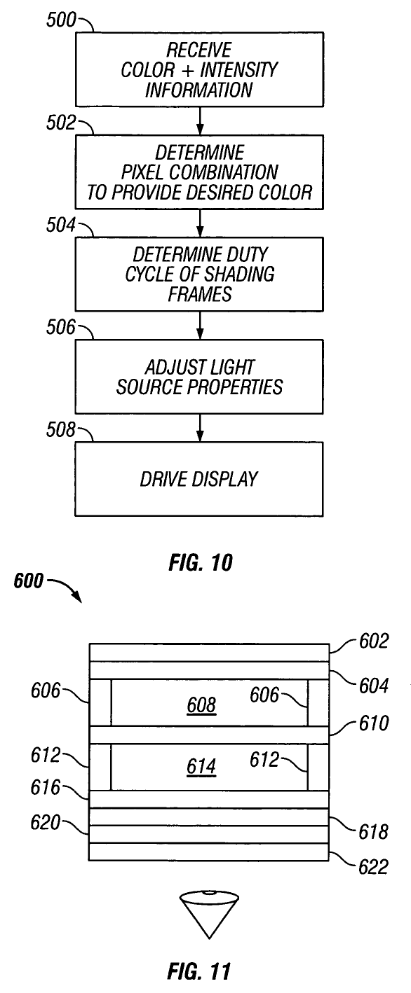

FIG. 10 illustrates the operation of control processor 408. At block 500, control processor 408 receives color and intensity information regarding pixel elements 402a-i. In block 502, control processor 408 determines the number and location of pixels set to reflect light from light source 410 during its red cycle, its blue cycle and its green cycle. In block 504, control processor 408 determines the duty cycle of shading frames. The shading frames are black frames with all or a portion of the pixel elements 402a-i actuated in order to reduce the intensity of the color displayed by integrating a predetermined amount of black shading into the displayed color. In block 506, control processor 408 determines the color duty cycles, the rate of color change and intensity of the light transmitted by light source 410. In block 508, control processor 408 drives display 400 in accordance with the parameters determined above.

FIG. 11 provides an alternative structure for the interferometric modulator. Modulator 600 comprises a lower electrode 622, typically fabricated from ITO. On top of electrode 622 is a first dielectric 620 such as SiO₂ is deposited. Above dielectric 620 is deposited a thin layer of absorber/conductor material 618 such as chrome and above the absorbing layer is an electrically isolating layer 616, which is fabricated from a material such as Al₂O₃. A first set of posts 612 are provided to support mirror 610 so as to form first optical cavity 614. The mirror 610 is typically fabricated from aluminum and may also act as an electrode. Above mirror 610 are a second set of posts 606, which are provided to support dielectric layer 604, which in the exemplary embodiment is composed of SiO₂. This results in the formation of second cavity 608. Above dielectric layer 604 is a high electrode 602. This modulator when viewed from below will display black in the unactuated state. When a field is applied between mirror 610 and electrode 602, causing cavity 608 to collapse, the modulator will have a spectral response defined in part by a vertical dimension of the optical cavity. When a field is applied between mirror 610 and electrode 622, causing cavity 614 to collapse, the modulator becomes a broadband mirror capable of high reflectance of all frequencies of incident light. In some embodiments, layer 616 is very thin, thereby minimizing a separation distance between the mirror 610 and a substrate (not depicted) configured below electrode 622 when the cavity 614 is collapsed. In one embodiment, layer 616 is 100 Angstroms thick.

This modulator operates as described with respect to other exemplary embodiments described above, but operates in a mode wherein the unactuated color is black, i.e. low reflectivity. This could have the advantage of reducing the number of pixels that need to be actuated in order to write an image, for example, in an image having a substantial portion that is black.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

1. A display device, comprising:
at least one interferometric light modulator configured to reflect light, said at least one interferometric light modulator having a spectral response including two or more reflectance peaks in the visible spectrum; and
a light source having an emission spectra that includes at least one emission peak at least partially overlapping one of said two or more reflectance peaks.

2. The device of claim 1, further comprising a light guide configured to propagate light to said at least one interferometric light modulator.

3. The display device of claim 2, wherein said light source includes a plurality of emission peaks at least partially overlapping a plurality of said two or more reflectance peaks.

4. The display device of claim 3, wherein the light guide is configured to select at least one of said emission peaks.

5. The display device of claim 1, wherein said at least one interferometric light modulator comprises an optical cavity formed by a pair of reflective surfaces having a gap therebetween.

6. The display device of claim 5, wherein said gap defines a cavity height that produces said two or more reflectance peaks in said spectral response.

7. The display device of claim 1, further comprising a plurality of interferometric light modulators, wherein each of the plurality of interferometric light modulators has an optical cavity comprising an open state and a closed state, wherein the plurality of interferometric light modulators are configured to have essentially the same spectral response in an open state and essentially the same spectral response in a closed state.

8. The display device of claim 1, wherein said spectral response of said at least one interferometric light modulator includes three or more reflectance peaks in the visible spectrum, said three or more reflectance peaks comprising red, green and blue color peaks.

9. The display device of claim 1, further comprising an array of pixel elements, each pixel element comprising at least one interferometric light modulator.

10. The display device of claim 9, wherein said control system is configured control reflectance of said at least one interferometric modulator in said pixel elements such that said pixel elements display said image.

11. The display device of claim 9, further comprising a control system configured to receive a display signal for an image and configured to control illumination of said pixel elements such that said pixel elements display said image.

12. The display device of claim 11, wherein said control system is configured to control a color sequence, duty cycle, or intensity of light with which said pixel elements are illuminated.

13. The display device of claim 1, wherein the light source comprises a light emitting diode.

14. A display device, comprising:
means for interferometrically modulating light, wherein the means for modulating light is capable of reflecting light having a plurality of intensity peaks in the visible spectrum;
means for selectively illuminating said means for interferometrically modulating light with light including at least said plurality of intensity peaks in the visible spectrum; and
means for controlling the selective illumination of said means for interferometrically modulating light.

15. The display device of claim 14, wherein said means for controlling the selective illumination of said means for interferometrically modulating light is configured to control a color sequence, duty cycle, or intensity of light with which said means for interferometrically modulating light is illuminated.

16. The display device of claim 15, further comprising means for directing light from said means for illuminating to said means for modulating light.

17. The display device of claim 14, wherein the plurality of intensity peaks in the visible spectrum comprises either red, green, and blue color peaks or cyan and yellow color peaks.

18. A method of manufacturing an interferometric light modulating device, comprising:
providing a plurality of pixel elements, each pixel element comprising at least one interferometric light modulator having a spectral response that includes two or more reflectance peaks in the visible spectrum; and
providing a light source configured to selectively illuminate said plurality of pixel elements with light having one or more spectral peaks substantially overlapping said two or more reflectance peaks.

19. The method of claim 18, further comprising positioning a spectral filter in an optical path between said light source and said pixel elements, said spectral filter configured to produce said one or more spectral peaks.

20. The method of claim 18, further comprising positioning a light guide with respect to said light source and said pixel elements to convey light from said light source to said pixel elements.

21. The method of claim 20, wherein said light guide is configured to produce said one or more spectral peaks.

22. The method of claim 21, wherein the interferometric light modulators each comprise an optical cavity formed by a pair of reflective surfaces separated by a distance.

23. The method of 18, wherein the at least one interferometric light modulator of the plurality of pixel elements each comprising an optical cavity having an open state and a closed state, wherein the at least one interferometric light modulator of the plurality of pixel elements are configured to have essentially the same spectral response in an open state and essentially the same spectral response in a closed state.

24. The method of claim 18, wherein said at least one interferometric light modulator is configured to reflect light including three or more intensity peaks in the visible spectrum, said three or more intensity peaks comprising red, green and blue color peaks.

25. The method of claim 18, further comprising providing a control system configured to control selective illumination of the pixel elements with said one or more spectral peaks.

26. The method of claim 25, wherein said control system is configured to control color sequence, duty cycle, or intensity of light with which said pixel elements are illuminated.

27. The method of claim 25, wherein said control system is configured to switch said interferometric modulators in said pixel elements between different output states.

28. The method of claim 18, wherein the light source comprises a light emitting diode.

29. An interferometric light modulating device, comprising:
a plurality of pixel elements, each pixel element comprising an interferometric light modulator switchable between different reflective states; and
an illumination apparatus configured to selectively illuminate the plurality of pixel elements with light of different color at different times.

30. The device of claim 29, further comprising a control system configured to control sequential illumination of said pixel elements with said color light to produce a desired color by color fusion.

31. The device of claim 29, wherein further comprising a control system configured to control said reflective states of said pixel elements.

32. A display device, comprising:
an illumination apparatus configured to emit light comprising an emission spectra having a spectral output that varies with time;
at least one light modulating device configured to reflect light from said illumination apparatus, said at least one light modulating device comprising an optical cavity formed by a pair of reflective surfaces; and
a control system configured to vary the spectral output of the illumination apparatus.

33. The display device of claim 32, wherein said at least one light modulating device is a broadband light modulating device.

34. The display device of claim 32, wherein said control system is configured to select different reflective states of the at least one light modulating device.

35. An interferometric light modulating device, comprising:
means for interferometrically modulating light switchable between different reflective states; and
means for selectively illuminating said means for interferometrically modulating light with light of different color at different times.
